(19) United States
(12) Patent Application Publication
(10) Pub. No.: US 2020/0162991 A1
(43) Pub. Date: May 21, 2020

(54) DEVICE AND METHOD FOR TIME AND FREQUENCY SEQUENCING FOR THE TRANSMISSION OF DATA PACKETS IN A MESH NETWORK

(71) Applicant: COMMISSARIAT A L'ENERGIE ATOMIQUE ET AUX ENERGIES ALTERNATIVES, PARIS (FR)

(72) Inventors: Pierre ROUX, Jouy en Josas (FR); Christophe JANNETEAU, Chaudon (FR)

(21) Appl. No.: 16/611,197

(22) PCT Filed: May 14, 2018
(86) PCT No.: PCT/EP2018/062302

§ 371 Date: Nov. 5, 2019

(30) Foreign Application Priority Data
May 15, 2017 (FR) 1754239

(51) Int. Cl. H04W 40/02; H04W 72/08; H04W 28/10; H04W 84/18

(52) U.S. Cl. CPC H04W 40/02; H04W 84/18; H04W 28/10; H04W 72/08

(57) ABSTRACT

A method implemented by computer for transmitting data packets in a mesh network is provided, which is collision-free and which makes it possible to guarantee bounded latencies for end-to-end communications.

### FIELD OF THE INVENTION

The invention relates to the field of telecommunications and in particular to a time and frequency sequencing device and method for the transmission of data packets in a mesh network.

### STATE OF THE ART

Mesh networks organized around sensors and actuators are composed of a set of nodes in which each node is likely to support one (or several) sensor(s) or actuator(s), and to communicate by radio with other nodes which are within radio range, so as to allow an uploading of measurements (and respectively a routing of commands) to (and respectively from) a central or gateway node. The gateway node makes it possible to link the network of sensors to another encompassing network, typically the Internet, and any communication between a mesh node network and an external node necessarily takes place via the gateway node.

The measurements and the commands, and a certain number of service messages, are formatted in the form of data packets. A node may thus be required to transmit data packets for itself if it wants to transmit a measurement from a local sensor, or else receive data packets if it receives a command concerning it. A node can also transmit and/or receive data packets on behalf of another node originating the measurement or the destination for the command. In order to allow the communications between the nodes and the gateway, the mesh network offers a routing functionality which assumes a tree-structured topology between the nodes and the gateway, as illustrated in FIG. 1. The routing topology makes it possible to assign a parent node to each node in the network (100). When a source node, for example ‘X’, has to transmit a packet to the gateway ‘C’ for itself or on behalf of another node, it must transmit it to its parent node ‘Y’. The packet arrives at the gateway step-by-step by successive hops according to a routing path in which each intermediate node ‘Y, Z’ must relay the packet to its parent. The number of hops necessary to get back to the gateway is a characteristic of the source node which is designated as being the “rank” of this node. In the example illustrated in FIG. 1, the source node ‘X’ is of rank 3.

In the other direction, when packets have to be routed from the gateway to a particular node in the network, the transmission still takes place hop-by-hop by transmitting the packet to a child node, in principle to that of the child nodes which allows the best routing, in the destination node. In this direction, the nodes can be required to know the topology of the subnetwork of their downstream nodes, so as to determine the child node to which to send the packet, given the destination node. Nevertheless, in variant implementations, only the gateway node knows the subnetwork topology, and the exhaustive information on the route to be followed to reach the target node is incorporated by the gateway node in the downstream data packets.

Once the routing topology is established, the packet transmission rules are established in order to determine when a node can transmit, and on which radio channel for the cases where the network is deployed on several channels and not just one. The possibility of transmitting over several radio channels makes it possible to benefit from performance enhancements, by exploiting the diversity of the fading phenomena on said channels. Generally, these questions (when to send, and on what channel) are addressed by the MAC (Medium Access Layer) layer. Two classes of solutions can be considered, the one for synchronous networks and those for asynchronous networks.

The known solutions implemented in the context of the asynchronous networks do not require the implementation of any time base, the nodes being authorized to transmit at any moment. However, this flexibility is reflected by collision phenomena: two nearby nodes may be required to transmit a packet at the same moment or else at moments so close to one another that there is simultaneous transmission during at least a part of the transmission time of a packet. The reception of these simultaneous packets by their recipient nodes (even possibly the single recipient node) can be made impossible, because one of the transmitters can behave as a source of interference with respect to the other.

There are mechanisms for reducing the influence of the collisions in the asynchronous networks based on known algorithms such as CSMA “Carrier Sense Multiple Access” or ALOHA. They consist in implementing reverse communications of acknowledgements of the packets received, and in retransmitting the packets in the absence of acknowledgement, until the packets are correctly received by the recipient neighboring node, or even until a maximum number of retransmissions is reached. To avoid repeated collision phenomena, the nodes must wait for a random time period before proceeding with the retransmission. It then becomes improbable that two nodes involved in a first collision might choose the same waiting time, and the retransmissions then typically take place without collisions.

However, the asynchronous systems present drawbacks, including two major ones:
They do not guarantee a deterministic latency: the transmission of a packet over several hops can give rise “by misfortune” to very many collisions, each of them leading to not inconsiderable delays. The end-to-end latency is then not “bounded”.

They assume a network with little load for them to operate correctly. The performances are all the poorer when the network is loaded and vary according to a law which is more exponential than linear, the collisions creating other collisions. Thus, an asynchronous network in which the radio links might be used at more than 10% of their total capacity would be unusable in practice.

The synchronous networks can resolve the limitations of the asynchronous networks, but at the cost of increased complexity. In these networks, the gateway node can act as synchronization source. The synchronization from the gateway node can be transmitted from hop to hop to all of the network, by adopting a tree-structured topology similar to that of FIG. 1. The time base implemented in these networks consists typically of a frame structure which is repeated indefinitely. A frame consists of a set of successive time units, or “timeslots”, in which it is possible to transmit a data packet. In some systems, the timeslot allows both the transmission of a data packet from a node to another neighboring node, followed by the reception of an acknowledgement message in the reverse direction. Such is for example the case of the system defined in the IEEE 802.15.4^{e} standard. Each time a packet is transmitted from a parent node to a child node, the child node with the possibility of synchronizing or resynchronizing its local time base with that of its parent. The communications in the reverse direction, from a child node to a parent node, can themselves also contribute to the resynchronization, through an acknowledgement message. If no message is ever transmitted between a parent and its child during a certain time period, in any of the directions, the synchronized systems generally force a service packet whose sole end is to prevent synchronization drift. An entirely synchronized system can then be assumed in which the synchronization errors do not exceed certain limits. The timeslot structure makes it possible to tolerate this maximum synchronization error.

The time sequencing mechanism must be defined to establish when a node is authorized to transmit a packet to its parent or one of its children, and what channel, if the network has several independent radio channels. The issue is then to determine on what timeslot and on what radio channels, the transmissions from a node to its parent or one of its children are authorized, the combination of a time unit (the “timeslot”) with a radio channel being commonly designated by the term cell. FIG. 2 makes it possible to illustrate, on a frame structure containing a plurality of time units which cells authorize on which radio channel the bidirectional communications between a parent node ‘Y and one of its child nodes ‘X’ to ensure collision-free communications, while minimizing the end-to-end latency.

A person skilled in the art accepts that the notion of cell can refer to a “logical” rather than “physical” radio channel. By assuming for example the availability of 16 radio channels, it is possible to assign logical channels ranging from 0 to 15, and assume the choice of the physical channel used will be a function of the logical channel, and of a particular “frequency hopping” function according to an equation of the following type:

physical_channel=(logical_channel+fh(timeslot))%16

given that the physical channels are themselves also identified by indexes ranging from 0 to 15. This frequency hopping function is assumed to be pseudo-random. It guarantees, for example, that, in case of retransmissions, the retransmissions do not take place (except by misfortune) on the same physical channels, while they may take place on the same logical channels.

Sequencing mechanism solutions are known. For example, the “slotted ALOHA” mode which consists in using the ALOHA retransmissions mentioned previously in the context of the asynchronous networks, and in applying them to the frame structures of the synchronous networks. In this configuration, a node is authorized to transmit at any moment. If a collision (or any other transmission problem) is detected by an absence of acknowledgement, a retransmission is planned in a next cell. The random time period mentioned previously in the context of the asynchronous networks is then a waiting time expressed according to an integer and random number of timeslots (within the limit of a maximum number). However, the “slotted ALOHA” systems offer few advantages over the ALOHA systems for asynchronous networks, and they do not escape from the two major drawbacks cited previously.

Other approaches exist, such as the Orchestra system presented in the article by Duquennoy at al. “Orchestra: Robust Mesh Networks Through Autonomously Scheduled TSCH”. This solution is interested in the networks conforming to the IEEE 802.15.4^{e} standard which defines a standard technology for creating synchronous mesh networks. It is based in particular on the TSCH “Time Slotted Channel Hopping” mode and proposes a method for defining the use of the cells. Orchestra typically introduces 4 classes of cells:
the shared cells available for all the nodes;
the shared cells “based on the receiver”: the identification of the cell (the timeslot and the logical radio channel) is based on the characteristics of the receiver, for example its MAC address. Each node listens on its own cell(s) based on the receiver;
the shared cells “based on the transmitter”: the identification of the cell (the timeslot and the logical radio channel) is based on the characteristics of the transmitter, for example its MAC address. This type of cell can be used for the transmission of local “broadcast” frames; and
the dedicated cells.

In practice, the Orchestra approach and its implementation in the Open Source “Contiki-OS” system uses only the first three classes of cells, and the article establishes that the performance levels of systems using these three classes are superior to that “slotted ALOHA” systems. However, these solutions do not aim to eradicate the collisions in the network which remain possible because of the fact that two child nodes of one and the same parent may simultaneously transmit a packet to the cell based on the receiver of this parent node, such that the end-to-end latencies remain unbounded.

Thus, although there is the possibility in principle of designing a collision-free mesh network, no cell allocation method is proposed for minimizing the latency in the context of such networks. The known approaches present a certain number of drawbacks, in particular none makes it possible to propose a collision-free system, in which the latencies for the end-to-end packet transmissions are minimized.

There is then the need for a solution which mitigates the drawbacks of the known approaches. The present invention addresses this need.

### SUMMARY OF THE INVENTION

One object of the present invention is to propose a solution for the transmission of data packets in a mesh network, which is collision-free and which makes it possible to guarantee bounded latencies for the end-to-end communications.

Advantageously, the invention allows the communications to benefit from optimized latencies, given the constraint of absence of collisions.

The invention is advantageously applicable in the industrial areas designing communications solutions for wireless mesh networks, in industrial contexts in which the performance guarantee aspects are important, particularly for exploiting radio technologies based on a synchronous MAC layer implementing cells, such as the 802.15.4^{e} technology (TSCH mode). Thus, the present invention relates to the applications for mesh networks of smart grid, smart city type, or the industrial alliances such as the WI-SUN alliance (https://www.wi-sun.org/), or even the applications of smart home type, or the industrial alliances such as the Thread alliance (http://threadgroup.org/).

To obtain the results sought, a method and a device are proposed. In particular, there is proposed a method implemented by computer for transmitting data packets in a mesh network. The mesh network has a tree-structured routing functionality defining routing paths between a central node and a plurality of nodes, a routing path allowing a node to send/receive data to/from the central node in a certain number of hops defining the rank of the node, the routing path between a node of rank ‘n’ and the central node of rank ‘0’ consisting of a set of radio links between neighboring nodes. The method for uplink traffic transmitting data to the central node comprises the steps of:

generating a frame structure comprising a predefined number of sequentially-indexed time units, a time unit allowing the transmission of data between two nodes, and comprising at least one transmission radio channel, the association of a time unit with a radio channel defining a cell of the frame;

allocating, on behalf of each of the nodes of rank ‘1’, one or more cells of the frame to transmit data from a node to the central node; and

repeating, rank by rank, recurrently to the maximum rank defined in the network, the step of allocation of cells on behalf of each of the nodes of one and the same rank.

The step of allocation of cells on behalf of each of the nodes of one and the same rank ‘n’ is done node by node according to an arbitrary order, and it consists in:

allocating cells radio link by radio link on the path between a current node N and the central node, beginning with the link attached to the central node, the allocation of cells on a link between two nodes Ni and Nj consisting in a joint allocation on the nodes Ni and Nj on behalf of the node N, such that, for a cell allocated in transmission on the node Ni on a time unit and a radio channel, there is a corresponding cell allocated in reception on the node Nj on the same time unit and on the same radio channel, a joint allocation being carried out if:

a time unit is available in the node Ni; and

the same time unit is available in the node Nj; and

a cell corresponding to the time unit is allocated neither in transmission nor in reception on any radio channel to any of the neighboring nodes of the node Ni having a received radio signal strength level in reception (RSSI) higher than a minimum level; and

the same cell is allocated neither in transmission nor in reception on any radio channel to any of the neighboring nodes of the node Nj having an RSSI higher than a minimum level.

If, for a given link, there are several time units available, the cell which is allocated on behalf of a current node N is that having the time unit of the highest index in the frame.

For downlink traffic, in reception by a node of the network of data from the central node, the method comprises the steps of:

generating a frame structure comprising a predefined number of sequentially-indexed time units, a time unit allowing the transmission of data between two nodes, and comprising at least one transmission radio channel, the association of a time unit with a radio channel defining a cell of the frame;

allocating, on behalf of each of the nodes of rank ‘1’, one or more cells of the frame for receiving data from the central node; and

repeating, rank by rank, recurrently to the maximum rank defined in the network, the step of allocation of cells on behalf of each of the nodes of one and the same rank.

The step of allocation of cells on behalf of each of the nodes of one and the same rank ‘n’ is done node by node according to an arbitrary order, and it consists in:

allocating cells radio link by radio link on the path between the central node and a current node N, beginning with the link attached to the current node N, the allocation of cells on a link between two nodes Ni and Nj consisting in a joint allocation on the nodes Ni and Nj on behalf of the node N, such that, for a cell allocated in transmission on the node Ni on a time unit and a radio channel, there is a corresponding cell allocated in reception on the node Nj on the same time unit and on the same radio channel, a joint allocation being carried out if:

a time unit is available in the node Ni; and

the same time unit is available in the node Nj; and

a cell corresponding to the time unit is allocated neither in transmission nor in reception on any radio channel to any of the neighboring nodes of the node Ni having a received radio signal strength level in reception (RSSI) higher than a minimum level; and

the same cell is allocated neither in transmission nor in reception on any radio channel to any of the neighboring nodes of the node Nj having an RSSI higher than a minimum level.

If, for a given link, there are several time units available, the cell which is allocated on behalf of a current node N is that having the time unit of the lowest index in the frame.

According to embodiments of the method in uplink or downlink traffic:

the minimum RSSI level is predefined as being the level for a neighboring node to be liable to generate a collision;

comprises an additional step for communicating the cell allocation information to the nodes of the network;

comprises an initial step consisting in defining the topology of the routing tree for the mesh network;

the structure of the frame contains one or more cells shared between several nodes;

the frame contains a number of cells greater than or equal to the number of nodes of the network;

if, for a given link, there is no time unit available, there is no cell allocated.

The invention also covers a device for transmitting data packets in a mesh network comprising means for implementing the steps of the method claimed.

The invention can be implemented in a mesh network comprising a central node and a plurality of nodes capable of sending and receiving data during allocated time units. The mesh network can conform to the IEEE 802.15 4e standard in TSCH MAC mode.

The invention can work in the form of a computer program product which comprises code instructions making it possible to perform the steps of the method claimed when the program is run on a computer.

### DESCRIPTION OF THE FIGURES

Different aspects and advantages of the invention will emerge in support of the description of a preferred but nonlimiting implementation of the invention, with reference to the figures below:

FIG. 1 illustrates a mesh network environment making it possible to apply the method of the invention;

FIG. 2 illustrates, on a frame structure, cells authorizing, on a radio channel, bidirectional communications between a parent node and a child node;

FIG. 3 shows an example of frame structure making it possible to implement the method of the invention according to an embodiment;

FIG. 4 shows a sequencing of steps making it possible to implement a transmission data according to an embodiment of the invention;

FIGS. 5a to 5f show the different steps of allocation of cells according to an embodiment of invention;

FIG. 6 is a screen capture which graphically shows the allocation of cells for a node according to an embodiment of the invention.

### DETAILED DESCRIPTION OF THE INVENTION

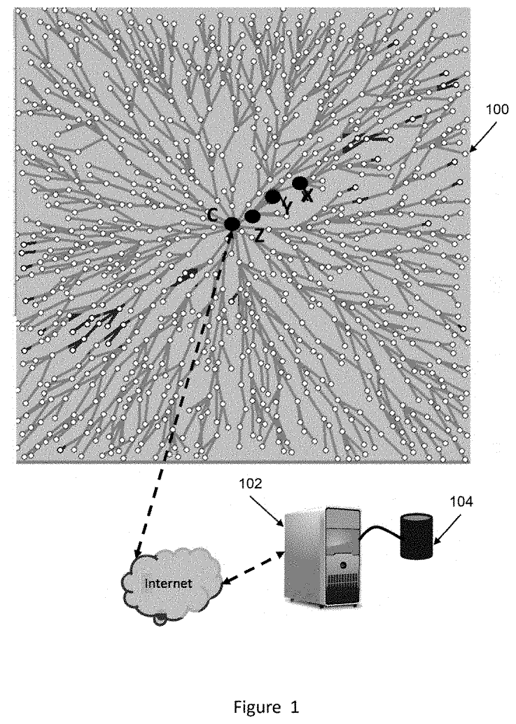

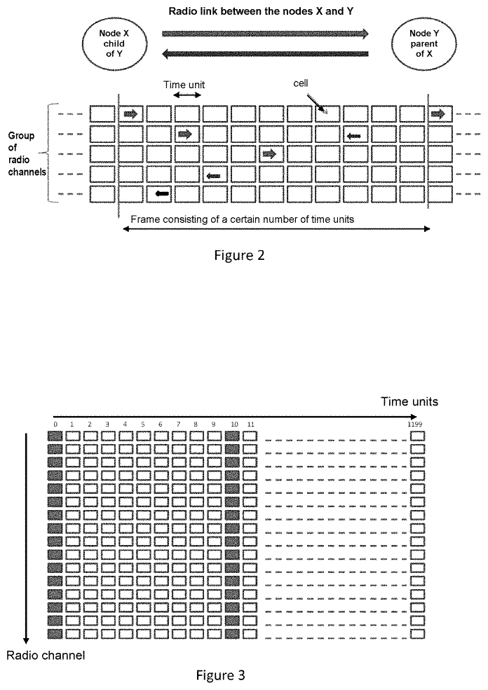

Generally, the method of the invention consists in implementing, in a mesh network (100) such as that of FIG. 1, a time and frequency sequencing mechanism for the transmissions of data packets, which guarantees the absence of collisions in the packet transmissions, while minimizing the transmission latency. The method is applied at a central entity which knows the topology of the network in terms of parent-child relationships and also in terms of “radio” proximity between the nodes likely to generate collision conditions. Based on this knowledge, the entity determines, according to the procedure of the invention, the cells which are authorized for bidirectional communications between each node and its parent, so as to avoid any collision in the network, and to minimize the end-to-end packet transmission latency, then transmits the information to all the nodes.

The central entity can typically be a machine in the Internet network (102) which can communicate with all the nodes of the mesh network via the gateway node. In a variant embodiment, the central entity can consist of a functional module of the gateway node ‘C’.

Reference is made to FIG. 3 which shows an example of a frame structure making it possible to implement the method of the invention in a mesh network such as that of FIG. 1. For the purposes of clarity of explanation, it is assumed that the nodes produce a measurement on each frame, and the method is applied to assign a dedicated cell to upload this measurement. For the purposes of simplicity of the explanation, it is also assumed that the number of nodes in the network is not likely to exceed 1080, and that a certain number of the cells are shared by all the nodes, and managed in the “slotted ALOHA” made, in order to allow a communication in the network necessary to the implementation of other types of cells.

In the example shown in FIG. 3, the frame structure consists of 1200 timeslots (0 to 1199). In a nonlimiting hypothesis, 120 timeslots are used for shared cells (shaded cells) and the 1080 timeslots remaining are then available to become dedicated cells (white cells) and 16 logical radio channels (0 to 15) are available.

The example described covers the “uplink” aspect, that is to say the uploading of measurements from the nodes to the gateway. The frame structure counts at least one timeslot per node in the mesh network. Advantageously, the method can make it possible to set a maximum number of nodes that the network is not wise to exceed in order for the central entity not to be forced to reconfigure the network with a new frame structure, for example if the network is extended, because the implementation of a new node would necessitate the adoption of a longer frame structure.

In one embodiment of the present invention, the central entity in charge of executing the method for allocating cells can adapt the size of the frame used as a function of the number of nodes present in the network so as to ensure that the number of cells is always greater than or equal to the number of nodes. It should be noted that any adaptation of the size of the frame then leads to a reconfiguration of the allocation of the cells for all of the network.

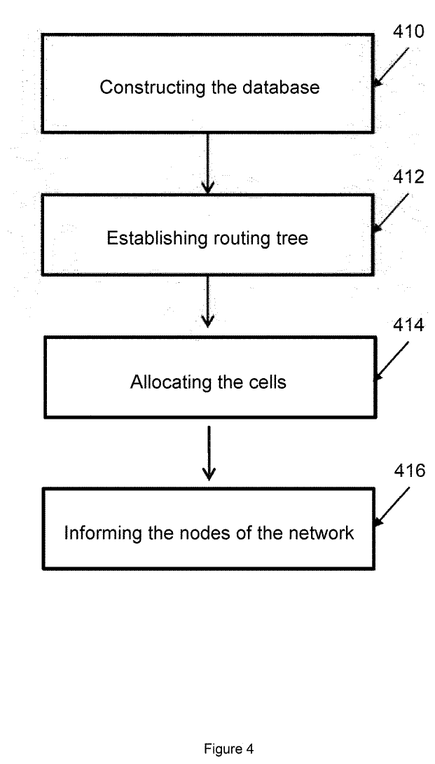

The new method of the invention consists in the allocation to the nodes of a mesh network of dedicated cell to allow the collision-free transmission of data by minimizing the end-to-end latency. The steps of allocation of the cells presuppose the pre-existence of a routing topology. FIG. 4 shows the general steps that make it possible to implement the cell allocation method. A preliminary step (410) consists in collecting information on the network in order to construct a database available for the central entity. This step, which can be performed according to different variants, is not described in detail, but it allows the central entity to have access to data representing each existing node of the network, such as:
the unique identifier of the node;
the list of all the identifiers of the neighboring nodes which are seen by the node concerned, or nodes said to be within operational coverage;
the list of the average “RSSI”s attached to the neighboring nodes. The RSSI (Received Signal Strength Indication) gives a measure of the strength in reception of a received radio signal.

To collect this information, a preliminary phase can consist in random transmissions of service packets by all the nodes of the network with inclusion of the unique identifier of the node in the message to be transmitted. Each node observes the signals transmitted by its visible neighbors and establishes the list of the neighbors associated with the average RSSI attached to this neighbor. Then, the collected information is communicated to the entity controlling the network and to the gateway node. The communication protocol can for example be a dissemination-based protocol.

The next step (412) consists in establishing the routing tree. In one implementation, the central entity for applying the cell allocation method will have prior knowledge of the routing topology. In a variant embodiment, the central entity can take charge of determining the routing topology and the allocating of the cells. This option requires a procedure of registration of the nodes in the network, which needs to involve the concept of mediator node. This is a node already registered in the network and known to the central entity. When a new node is placed in service (candidate node), it needs to have, in direct visibility, at least one node already registered in the network, which is capable of serving as mediator for it. It enters into direct communication with this mediator node to supply it with all the information that the central entity needs to incorporate it in the network: the identifier of the node (for example its MAC address) and the identification of all the nodes of the network which are visible to the candidate node, as well as the indication of the received strengths for all these neighbors. This information is then communicated by the mediator note to the central entity. The central entity can then take in account the incorporation of a new node in the network and communicate to the candidate node the information that allows it to be incorporated in the network, namely the identifier of its parent, possibly the identifier or identifiers of its children, and the possible dedicated cells which it wants to activate in this node. Moreover, the central entity can also communicate a new configuration to a certain number of other nodes, to take account of the incorporation of a new node in the network.

Assuming that an entire network is being put in place, an iterative process in which the nodes are progressively entered into the network starting from the gateway and working therefrom, has to be put in place. The gateway serves as mediator for entering the nodes of rank 1. Then, the nodes of rank 1 serve as mediators for entering the nodes of rank 2, and so on. Although a node which acts as mediator for a candidate node can subsequently become the parent of that candidate node, that is in no way an obligation and the central entity remains master of the choice of the parent nodes. Optionally, the central entity can keep up to date its view of the state of the nodes in the network, that is to say know, for each node, any change in the list of its visible nodes (the neighbors) and/or in the received strengths of neighbors which would be likely to introduce a reconfiguration of the routing tree by the central entity. To do that, the central entity can for example maintain a regular signaling with each of the nodes in order to collect this information and anticipate any possible reconfiguration of the routing tree. Thus, by way of example, any degradation of the connectivity of a node with its parent could lead to a reconfiguration of the routing tree (and consequently of the allocation of the cells for certain nodes of the network) in order to preserve a good connectivity for the node by associating with it a new parent. If a node suddenly loses any connectivity with its parent without the central entity having been able to be informed in advance, the node can re-execute the procedure of registration in the network (via a mediator node) in order for the central entity to detect the problem and reassign to this node a new parent while reconfiguring the allocation of the cells to take charge of this node, that is to say release the cells previously associated with this node, and reestablish the new cells.

The routing calculation step can be performed according to different variants that makes it possible to:
choose a threshold of operation on minimum received strength RSSI for establishing the parent-child communications, such that no parent-child relationship will be established between 2 nodes A and B if the RSSI of A received by B is below the minimum RSSI or else if the RSSI of B received by A is below this minimum;
establish the set of the nodes of rank 1 which are under coverage of the gateway and which satisfy the minimum RSSI; these are the nodes which see the gateway with a strength greater than or equal to the threshold of operation;
establish the set of the nodes of rank 2 which are under coverage of at least one node of rank 1 and which observe the minimum RSSI;
establish the sets of the nodes of rank N by recurrence from the nodes of rank N−1;
stop the process when the set of the nodes of rank “RANG_MAX+1” is empty.
The rank “RANG_MAX” is then the minimum rank in the network.

If the nodes have not been incorporated in a set of rank N, these nodes are considered to be unreachable, given the minimum RSSI constraint. It should be noted that the parent node of the nodes of rank 1 is the gateway node. Thus, for each node of rank N>1, the method assigns as parent node, the node which is of rank N−1, which forms part of the list of the neighbors and satisfies the minimum RSSI criterion, and for which the greatest RSSI out of the RSSIs of the nodes of all the ancestors on the path to the gateway is minimum.

Putting the routing tree in place makes it possible to add to the database additional information which is, for each node:
the rank of the node; and
the identifier of its parent node (except for the gateway node which has no parent).

By defining fixed points for the shared cells, a communication with the nodes of the networks is always possible via the shared cells, and can be exploited to implement dedicated cells. In this configuration where shared cells are available, a dynamic routing protocol (for example the RPL protocol) can be used on these shared cells to construct the routing tree. The central entity which is in charge of applying the method for allocating cells can then discover the routing tree by interrogating all the nodes of the network to know their respective parent, or even by interrogating only the gateway in the cases where the latter has an overview of the tree (for example with the RPL protocol in “non-storing” mode).

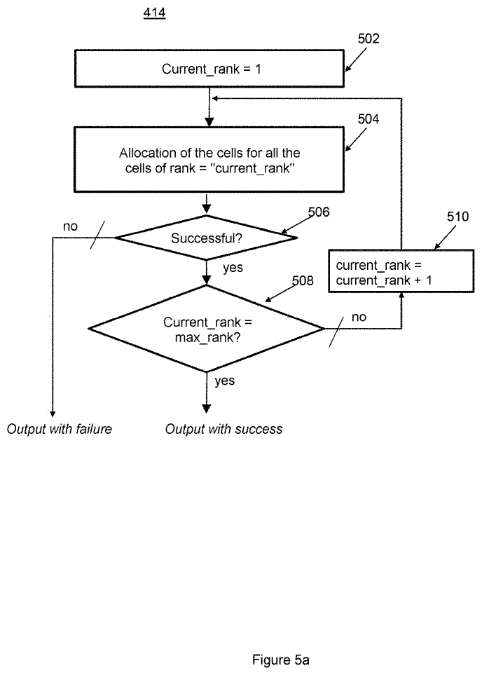

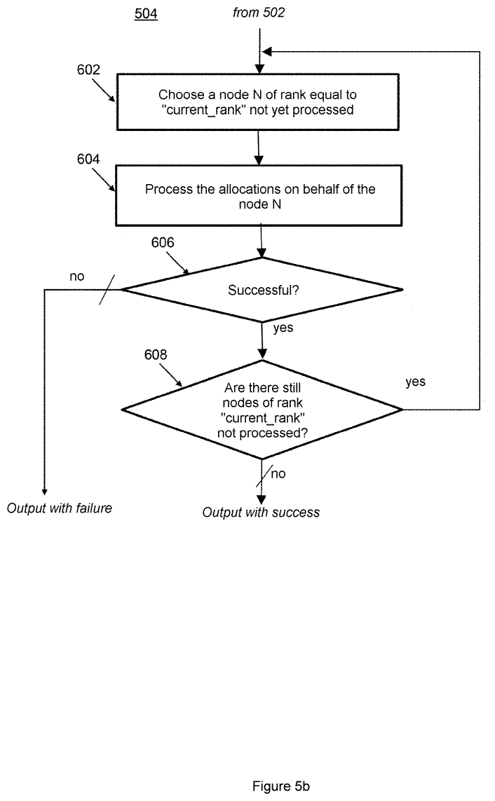

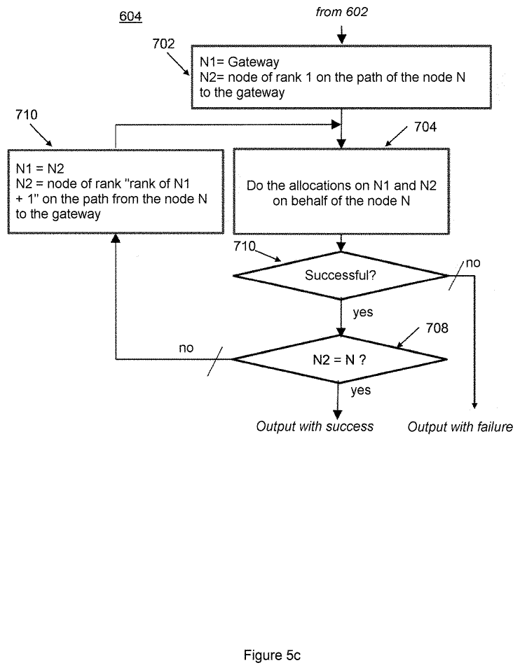

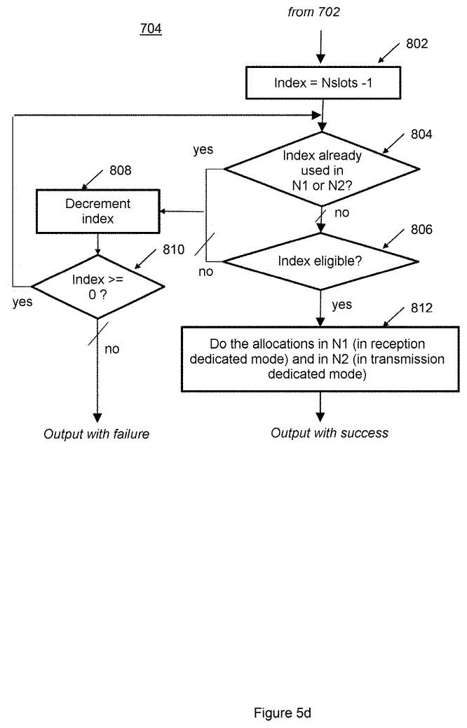

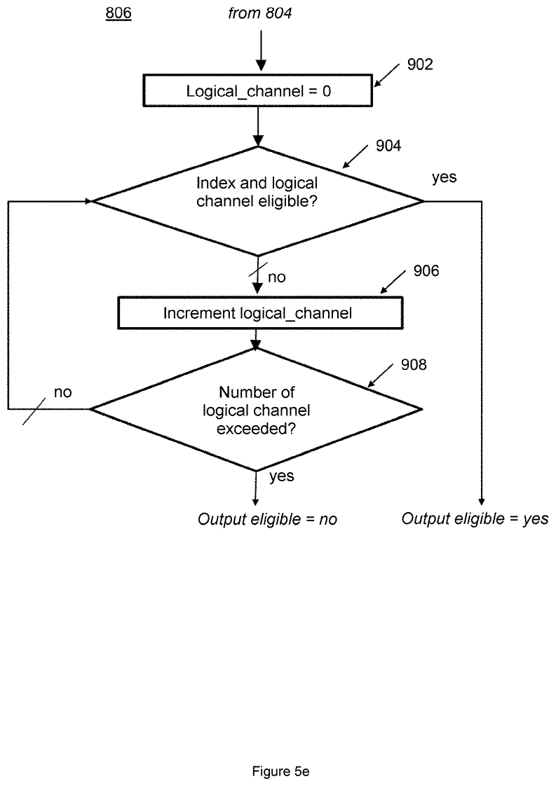

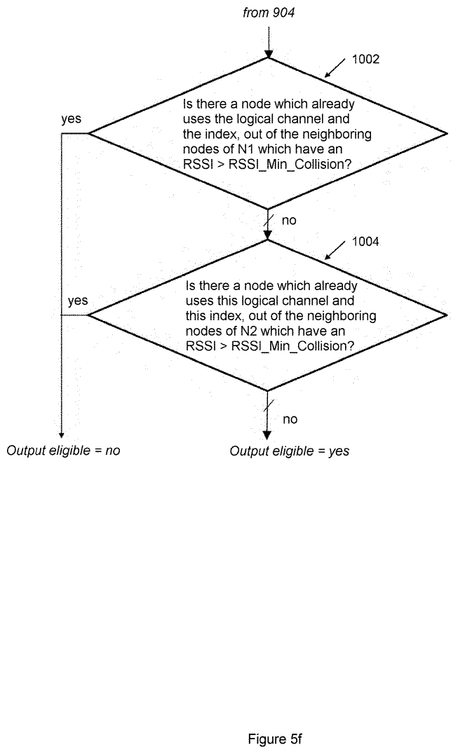

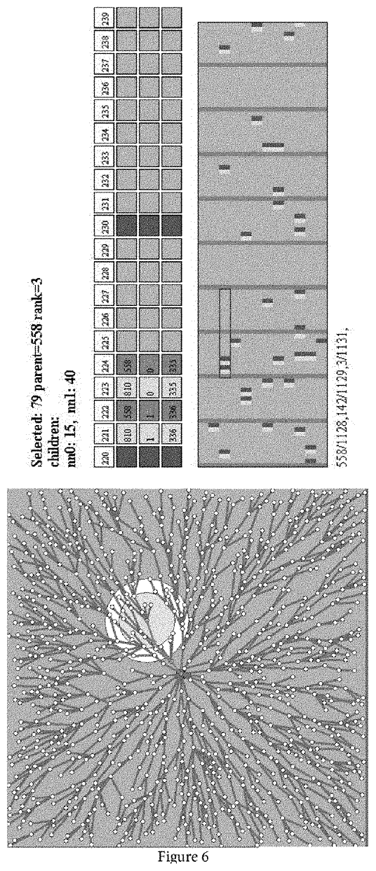

Once the routing functionality is established, the cell allocation method can be applied (414). The cell allocation steps are described with reference to FIGS. 5a to 5f, and make it possible to add to the database with cell usage tables. The tables are quadruplets of “table length=nSlots” length which define:
the mode: “Shared” or “Dedicated Receiver” or “Dedicated Transmitter”;
the identifier of the paired node (except for the shared mode);
the logical channel; and
the identifier of the node owning the cell (except for the shared mode).

Once the cell allocation method is completed, the complete configuration of the network can be disseminated (416) in the network. When the nodes receive the configuration of the network, they extract the configuration concerning them.

Generally, the allocation of the cells consists in setting the frame structure and in particular the number of timeslots in the frame. The latter should be at least equal to the number of nodes reachable.

As shown in the diagram of steps of FIG. 5a, the allocation of the cells in uplink mode for the uploading of measurements from the nodes to the gateway is done rank by rank, beginning with the rank 1 (502) to the highest rank. The allocation of the cells for all the cells of a current rank is done node by node (504). If the allocations are performed for all the nodes of the rank 1 (506), the method checks whether the maximum rank of the network is reached (508), and if not, goes on to the higher rank (510) to process the allocations node by node, for the nodes of rank 2, and so on, by recurrence up to the nodes of maximum rank (rang_max).

The allocation of the cells for the nodes of a given rank (504) is done node by node in arbitrary order (FIG. 5b). The method makes it possible to choose a node N not yet processed, of rank equal to the “current_rank” (602), then to proceed with the allocations of cells on behalf of this node (604). If the allocations are performed successfully (606, yes branch), the method checks whether there are still nodes of the current rank not yet processed (608) and if yes, loops back to the step of arbitrary selection of a node not yet processed (602), or then the node-by-node allocation method stops (608, no branch).

The allocation of the cells on behalf of a node of given rank (FIG. 5c) is done radio link by radio link on the path between this node and the gateway, each radio link being defined between two nodes, one of which acts as child and the other of which acts as parent. For uplink traffic to the gateway, the method starts the link-by-link allocation by beginning with the link attached to the gateway. For “downlink” traffic to a node of given rank, the method starts the link-by-link allocation with the radio link attached to this node.

In the example chosen, the gateway acts as parent for a child node of rank 1 attached by a radio link to the gateway (702). For a current node N, the method makes it possible to do the allocations on behalf of this node N, first of all on the gateway N1 and on the node N2 of rank 1 (704), then to check whether the allocations are yes or no performed successfully (706). When the allocations for the node N2 of rank 1 are performed successfully, the method checks (708) whether the current node N which is processed is a node of rank 1 and, if yes, stops, or else the method makes it possible to go on to the allocation of cells on behalf of a node of higher rank, which is on the path of the node N to the gateway (710), and thus continues the parent-child allocations up to the rank of the current node.

The allocation of parent-child cells for a given link consists in identifying an available timeslot in the frame (FIG. 5d). Since the timeslots of the frame are indexed (802), the search for a timeslot is done index by index starting from the maximum index in uplink traffic or else starting from the minimum index in downlink traffic, by observing the following constraints:
the timeslot of current index should not be already used, either in the parent node, or in the child node (804). If the timeslot is already used (yes branch), the method goes on to the timeslot of next index (808, 810). If the timeslot of current index is not already used (no branch),
the method determines whether, for this available timeslot, the index is eligible (806) and if it is possible to find a cell of the frame for which:
   no node under the coverage of the parent node uses this cell, whether it be in reception mode or in transmission mode; and
   no node under the coverage of the child node uses this cell, whether it be in reception mode or in transmission mode.

Verifying the eligibility of the index of the available timeslot (FIG. 5e) consists in checking (904) the eligibility of the index and of a logical channel, starting with the first logical channel (902) up to the logical channel of maximum index (906, 908).

Verifying the eligibility of the index and of a logical channel (FIG. 5f) consists in determining (1002), out of the neighboring nodes of the parent node which have an RSSI higher than a minimum RSSI level for a neighboring node to be likely to generate a collision “RSSI_Min_Collision”, whether there is one which already uses this logical channel and this index. If this logical channel and this index are not used (no from 1002) in these conditions, the method makes it possible to determine (1004), from among the neighboring nodes of the child node which have an RSSI higher than “RSSI_Min_Collision” if there is one which already uses this logical channel and this index. If this logical channel and this index are not used (no from 1004) in these conditions, the method makes it possible to do the planned allocations (812).

If several timeslots are eligible because they meet the constraints, the method selects the timeslot of maximum index in uplink traffic, and the timeslot of minimum index in downlink traffic.

If no available timeslot is found or if no cell meeting the above criteria is found, the complete procedure of allocation of the cells in the network ends on a failure.

Advantageously, the method of the invention makes it possible to avoid several types of collisions. Indeed, the communications over the radio links are typically acknowledged, and it is possible to observe collisions on the acknowledgements even though the transmission of the message is done without collision. The constraints for identifying and selecting timeslots included in the method make it possible to incorporate these two types of collisions.

FIG. 6 is a screen capture which illustrates an example of allocation of cells by application of the method of the invention in simulation. The example is for the allocation of the cells for a node which is represented in the mesh network at the center of two concentric disks, an operational disk and a visibility disk. The radius of the operation disk represents the operational coverage of the network, that is to say that nodes which are under this coverage can be associated in parent-child operational links with the selected node. No parent-child link is established between two nodes if the distance which separates them is greater than the radius of the disk. The radius of the visibility disk represents the visibility, that is to say that the node at the center of this circle sees all the nodes under coverage of this disk and is therefore likely to receive interferences coming from these nodes. However, some visible nodes, those which are within the visibility disk but not in the operational disk, remain ineligible for establishing parent-child links.

Advantageously, the simulator makes it possible to define configurable radii, and takes charge both of the construction of the routing topology and the allocation of the cells. In the example, the node selected to allocate cells to it is the node ‘79’ which is of rank 3 and its parent is the node ‘558’. It is indicated that the selected node has 15 nodes under operational coverage and 40 nodes under visibility. The screen capture shows, in a zoom, a part of the frame structure going from the timeslots 220 to 239. The frame as a whole is represented below in the form of a matrix in which each row represents a portion of 100 timeslots in the frame. The zone on which the zoom is performed (the timeslots going from 220 to 239) is represented on the matrix by a dark rectangle.

On the timeslots 220 to 239, it is shown that the timeslots 220 and 230 are shared, and that 4 dedicated cells have been assigned in the zone 220 to 230, namely the cells situated at the timeslots 221, 222, 223 and 224. The cells at the timeslots 221 and 223 are cells in reception mode, the cells at the timeslots 222 and 224 are cells in transmission mode. The first row of the zoom indicates the values of timeslots (220 to 239). The second row indicates the identifier of the child or parent node that is being listened to or to which there is transmission. Thus, for the cells 222 and 224, the parent node is the node ‘558’ and the child node is the node ‘810’. The third row of the zoom indicates the logical radio channel. Thus, for the cells 221 and 222, the logical radio channel is the channel ‘1’, and for the cells 223 and 224, the logical radio channel is the channel ‘0’. The fourth row of the zoom indicates the identifier of the node on behalf of which the cells are assigned. Thus, the timeslots 221 and 222 are used on behalf of the node ‘336’, the timeslots 223 and 224 are used on behalf of the node ‘335’. The node ‘79’ selected therefore serves as router on behalf of the nodes 335 and 336. It serves as router also for other nodes, but the zoom represented does not show it, whereas the overview of the frame shows it well. The example shows an optimization of the latency aspects. Indeed, a packet in the name of the node ‘336’ is received on the timeslot 221 and forwarded on the timeslot 222. Likewise, a packet on behalf of the node ‘335’ is received on the timeslot 223 and forwarded on the timeslot 224. In both cases, the relayed packet stays no longer than one timeslot in the selected node which serves as relay node, which corresponds to the optimal performance. A simulation performed with the cell assignments, calculated for the network as represented in the screen capture, has established that no collision is observed in the network, even when the maximum capacity is reached, that is to say the use of the gateway is very close to 100% of the time, and has established that the performance levels in terms of end-to-end latency are very good. In particular, the delivery of a measurement produced by a node never exceeds the duration of a frame when the radio conditions are satisfactory.

As explained previously, the method for allocating cells must be performed once again after any event likely to modify the characteristics of the network, such as:
the commissioning of new nodes;
the stopping of nodes (by the battery being drained, failure, etc.);
modifications to the environment affecting the concepts of radio proximity (such as new urban constructions, a change of vegetation, etc.).

The central entity must then communicate the new configuration of the network to the affected nodes.

A detailed description has been given to present the principles of the invention on an uplink transmission mode from the nodes of the network to the central node, but the latter can be adapted and applied for a downlink transmission mode from the central node to the nodes of the network.

A person skilled in the art accepts that the invention can be implemented from hardware and/or software elements. It can be available as computer program product on a computer-readable medium. The medium can be electronic, magnetic, optical, electromagnetic or be of infrared type. Such media are, for example, semiconductor memories (Random Access Memory RAM, Read-Only Memory ROM), tapes, diskettes or disks, magnetic or optical (Compact Disk-Read Only Memory (CD-ROM), Compact Disk-Read/Write (CD-R/W) and DVD).

1. A method implemented by computer for transmitting data packets in a mesh network, the mesh network having a tree-structured routing functionality defining routing paths between a central node and a plurality of nodes, a routing path allowing a node to send/receive data to/from the central node in a certain number of hops defining the rank of said node, the routing path between a node of rank ‘n’ and the central node of rank ‘0’ consisting of a set of radio links between neighboring nodes, the method comprising the steps of:
generating a frame structure comprising a predefined number of sequentially-indexed time units, a time unit allowing the transmission of data between two nodes, and comprising at least one transmission radio channel, the association of a time unit with a radio channel defining a cell of the frame;
allocating, on behalf of each of the nodes of rank ‘1’, one or more cells of the frame for transmitting data from a node to the central node;
repeating, rank by rank, recurrently to the maximum rank defined in the network, the step of allocation of cells on behalf of each of the nodes of one and the same rank;
the step of allocation of cells on behalf of each of the nodes of one and the same rank ‘n’ being done node by node according to an arbitrary order, and consisting in:
allocating cells radio link by radio link on the path between a current node N and the central node, beginning with the link attached to the central node, the allocation of cells on a link between two nodes Ni and Nj consisting in a joint allocation on the nodes Ni and Nj on behalf of the node N, such that, for a cell allocated in transmission on the node Ni on a time unit and a radio channel, there is a corresponding cell allocated in reception on the node Nj on the same time unit and on the same radio channel, a joint allocation being carried out if:
a time unit is available in the node Ni; and
the same time unit is available in the node Nj; and
a cell corresponding to the time unit is allocated neither in transmission nor in reception on any radio channel to any of the neighboring nodes of the node Ni having a received radio signal strength level in reception (RSSI) higher than a minimum level; and
the same cell is allocated neither in transmission nor in reception on any radio channel to any of the neighboring nodes of the node Nj having an RS SI higher than a minimum level.

2. The method as claimed in claim 1, wherein, if, for a given link, there are several time units available, the cell which is allocated on behalf of a current node N is that having the time unit of the highest index in the frame.

3. The method implemented by computer for transmitting data packets in a mesh network, the mesh network having a tree-structured routing functionality defining routing paths between a central node and a plurality of nodes, a routing path allowing a node to send/receive data to/from the central node in a certain number of hops defining the rank of said node, the routing path between a node of rank ‘n’ and the central node of rank ‘0’ consisting of a set of radio links between neighboring nodes, the method comprising the steps of:
generating a frame structure comprising a predefined number of sequentially-indexed time units, a time unit allowing the transmission of data between two nodes, and comprising at least one transmission radio channel, the association of a time unit with a radio channel defining a cell of the frame;
allocating, on behalf of each of the nodes of rank ‘1’, one or more cells of the frame for receiving on a node data from the central node;
repeating, rank by rank, recurrently to the maximum rank defined in the network, the step of allocation of cells on behalf of each of the nodes of one and the same rank;
the step of allocation of cells on behalf of each of the nodes of one and the same ‘n’ being done node by node according to an arbitrary order, and consisting in:
allocating cells radio link by radio link on the path between the central node and a current node N, beginning with the link attached to the current node N, the allocation of cells on a link between two nodes Ni and Nj consisting in a joint allocation on the nodes Ni and Nj on behalf of the node N, such that, for a cell allocated in transmission on the node Ni on a time unit and a radio channel, there is a corresponding cell allocated in reception on the node Nj on the same time unit and on the same radio channel, a joint allocation being carried out if:
a time unit is available in the node Ni; and
the same time unit is available in the node Nj; and
a cell corresponding to the time unit is allocated neither in transmission or in reception on any radio channel to any of the neighboring nodes of the node Ni having a received radio signal strength level in reception (RSSI) higher than a minimum value; and
the same cell is allocated neither in transmission nor in reception on any radio channel to any of the neighboring nodes of the node Nj having an RSSI higher than a minimum level.

4. The method as claimed in claim 3, wherein, if, for a given link, there are several time units available, the cell which is allocated on behalf of a current node N is that having the time unit of the lowest index in the frame.

5. The method as claimed in claim 1, wherein the minimum RSSI level is predefined as being the level for a neighboring node to be liable to generate a collision.

6. The method as claimed in claim 1, further comprising a step of communicating the cell allocation information to the nodes of the network.

7. The method as claimed in claim 1, comprising an initial step consisting in defining the topology of the routing tree for the mesh network.

8. The method as claimed in claim 1, wherein the structure of the frame contains one or more cells shared between several nodes.

9. The method as claimed in claim 1, wherein the frame contains a number of cells greater than or equal to the number of nodes of the network.

10. The method as claimed in claim 1, wherein there is no cell allocated if, for a given link, there is no time unit available.

11. A device for transmitting data packets in a mesh network comprising means for implementing the steps of the method as claimed in claim 1.

12. A mesh network comprising a central node and a plurality of nodes capable of sending and receiving data during allocated time units, the network comprising a device as claimed in claim 11.

13. The mesh network conforming to the IEEE 802.15 4^{e} standard in TSCH MAC mode comprising a device as claimed in claim 11.

14. A computer program product, said computer program comprising code instructions making it possible to perform the steps of the method as claimed in claim 1, when said program is run on a computer.
